(19) United States
(12) Patent Application Publication
(10) Pub. No.: US 2010/0277941 A1
(43) Pub. Date: Nov. 4, 2010

(54) LED HEADLIGHT

(75) Inventors: Peter Frey, Heidenheim (DE); Christian Meier, Munich (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/743,575

(22) PCT Filed: Nov. 17, 2008
(86) PCT No.: PCT/EP08/09725

§ 371 Date: May 19, 2010

(30) Foreign Application Priority Data
Nov. 19, 2007 (DE) 10 2007 055 165.9

(51) Int. Cl. B60Q 1/04

(52) U.S. Cl. 362/547

(57) ABSTRACT

An LED headlight may include at least one heat-conducting element that extends from at least one heat source located in a headlight housing to at least one cooling element in such a way as to make thermal contact and which is arranged at least partially outside on the headlight housing, the heat-conducting element being movable.

The invention relates to an LED headlight, in particular for use in vehicles, more specifically motor vehicles.

Particularly when use is made of LEDs in motor vehicle headlights, it can be necessary to have to cool the LED light sources because of thermal problems that arise.

Previous attempts at a solution are passive cooling by the use of heat sinks inside a headlight. These are supported in part by active components such as blowers which circulate the air in the headlight housing. However, these solutions are comparatively complicated and not very effective. Again, they are comparatively large in volume and thereby impede a frequently desired adjustment of the headlights.

It is the object of the present invention to provide a simple, space-saving and effective cooling of LED headlights.

This object is achieved by means of an LED headlight as claimed in claim 1.

According to the preamble, the LED vehicle headlight has at least one light emitting diode (LED) as light source. What is involved is, exclusively, LED headlights fitted with LED lamps, as well as LED headlights with a mixture of LED lamps and non-LED lamps, for example incandescent lamps, xenon lamps etc (LED hybrid headlights). Each LED lamp has at least one LED as light source. Furthermore, there is present at least one heat-conducting element that extends from at least one heat source located in a headlight housing to at least one cooling element in such a way as to make thermal contact, the cooling element being arranged at least partially outside on the headlight housing.

The heat-conducting element is configured to dissipate heat from the at least one heat source. Typically occurring as heat sources are the LEDs (as primary heat source) and/or, in a secondary fashion thereto, components connected for operating them, for example a printed circuit board carrying the LED(s), holder (base), and so on. Further heat sources can include electronic modules, for example driver modules for operating at least one LED. The heat-conducting element is therefore connected on one side, in such a way as to make thermal contact, to at least one of the heat sources (LED directly or indirectly via printed circuit board, holder etc and/or electronic module etc) and is connected on another side, in such a way as to make thermal contact, to a cooling element attached to the headlight housing. Consequently, the heat-conducting element provides a thermal bridge between at least one of the heat sources and the cooling element arranged at least partially outside, as a result of which the heat conducted from the heat-conducting element to the cooling element can be dissipated effectively to the outside from the headlight. Each heat source can be connected via a dedicated heat-conducting element to an associated cooling element, while alternatively a plurality of heat sources can share a heat-conducting element. The cooling element or elements can be positioned on all sides of the headlight in the engine compartment. In other words, heat produced in the headlight housing is dissipated to the outside via the cooling element, which effectively dissipates heat. The cooling element preferably has effectively heat-conducting material (thermal conductivity λ particularly ≧15 W/(m·K), more specifically ≧200 W/(m·K)) such as, for example, made from metal, in particular iron, copper and/or aluminum, or else heat-conducting plastic, for example one that is mixed with carbon, in particular carbon nanotubes.

This LED headlight has the advantage of providing an effective, maintenance-free, space-saving and long-lasting cooling system for LED headlights. This also enables, in particular, high-power LED systems to be used inside closed systems. Specifically, as an advantage for motor vehicle manufacturers and/or suppliers, the result is that such an LED headlight can be used in existing motor vehicle structures at least at the interface level without, or with only slight, adaptation (retrofitting), and this is particularly advantageous for halogen or xenon headlights.

Particularly preferred for adjustment is a headlight in the case of which the heat-conducting element can be moved and/or adjusted mechanically. This enables adjustment of the headlight (for example with reference to optics, reflector and/or light source), since the heat-conducting element can be guided at the same time in the case of this sort of adjustment of position. This is advantageous, in particular, for automatic lighting range control.

A headlight can be advantageous in the case of which the heat-conducting element includes at least one (in particular movable and/or adjustable) heat pipe.

Particularly advantageous is an LED headlight in the case of which the heat-conducting element has at least two heat pipes and/or heat pipe sections that are in thermal contact with one another and are arranged displaceably in relation to one another. Movability can be achieved by means, for example, of a planar, sliding contact between two heat pipes and/or heat pipe parts.

However, also advantageous can be a headlight in the case of which the heat-conducting element includes a cooling circuit with at least one (in particular flexible) fluid line that is filled with a coolant. In this case, the coolant, in particular a liquid coolant, circulates in a fundamentally known way between the region bordering on the heat source and the region bordering on the cooling element.

The cooling circuit can be of passive design. For the purpose of increased heat dissipation, however, it can be advantageous when it has a pump for circulating the coolant.

Cooling elements can include passive heat sinks, such as cooling ribs, cooling pads, heat pipes etc., thermosyphons and/or also active cooling systems, for example with blower. It is also possible to make use together with the cooling element of existing cooling systems such as, for example, a cooling circuit of an air conditioning system; however, this is mostly associated with increased outlay on installation.

Preference is given to an LED headlight in the case of which the cooling element has an effectively heat-conducting heat transfer interface (thermal conductivity λ particularly ≧15 W/(m·K), more specifically ≧200 W/(m·K)) that is set up for fastening to a heat sink arranged outside the headlight housing. Cooling is already improved solely by the presence of the heat transfer interface because of the emission of heat to the outside. An (at least) bipartite configuration has the advantage of a high design flexibility, since only the heat transfer interface need be refashioned in the event of a change in housing shape and, conversely, different types of heat sink can easily be attached to the headlight housing.

It is preferred, furthermore, when the cooling element has a thermal convection heat sink, specifically for direct attachment to the housing and the heat-conducting element, or indirectly via the heat transfer interface.

It can also be preferred when the cooling element has a blower.

It can also be preferred when the cooling element has a thermosyphon.

The heat-conducting element is preferably guided through an opening in the headlight housing. The opening in the headlight housing can tightly surround the heat-conducting element. Alternatively, the opening can be so large that it surrounds the heat-conducting element at a distance.

In order to seal the opening, it can be advantageous when the LED headlight covers the opening, particularly on the outside. Alternatively, the heat-conducting element is led to a cooling element attached at a distance from the opening.

Particular preference is given to an LED headlight in the case of which the headlight housing is compatible (retrofitting) with a xenon headlight housing, and the cooling element instead of an electronic ballast for a xenon headlight is fastened on the headlight housing.

The heat-conducting element is preferably designed in a fashion widened toward the housing, for example in the shape of a funnel or cone toward the contact surface.

Again, further elements, for example thermally conductive films etc, can be present in the heat path between the heat source or LED and the cooling element.

In the following exemplary embodiments, the LED vehicle headlight is described schematically more precisely. Here, elements that are the same or act in the same way can be provided with the same reference numerals across a number of figures.

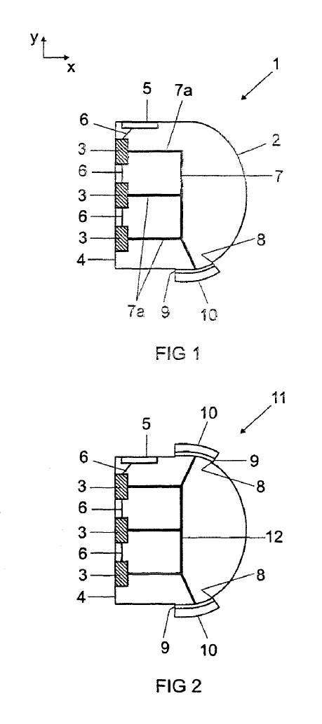

FIG. 1 shows an LED headlight in accordance with a first embodiment as a sectional illustration;

FIG. 2 shows an LED headlight in accordance with a second embodiment as a sectional illustration;

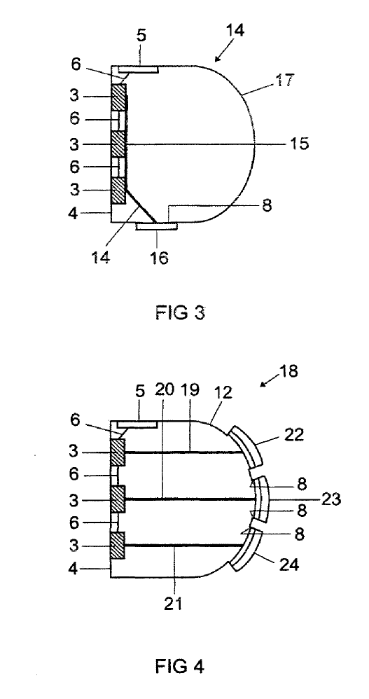

FIG. 3 shows an LED headlight in accordance with a third embodiment as a sectional illustration; and

FIG. 4 shows an LED headlight in accordance with a fourth embodiment as a sectional illustration.

FIG. 1 shows as a sectional illustration an LED headlight 1 in the case of which there are contained in a headlight housing 2 made from plastic three lamps (LED lamps) 3, equipped with light emitting diodes, as light sources that output their light through an optically transparent front side 4. The LED lamps 3 can serve, for example, as lower beam, upper beam or flasher. The LED lamps 3 are connected in common via a cable 6 to an electrical interface 5. The LED lamps 3 are connected in a fashion conducting heat, by means of a common movable heat pipe 7, to a heat transfer interface 9 that conducts heat effectively and is made from iron, copper, aluminum or alloys thereof. To be more precise, the heat pipe 7 bears on the one hand against a metal base of a respective LED cluster (not illustrated) of an associated LED lamp 3, that is to say indirectly, but in such a way as to conduct heat effectively, to the LEDs of the LED cluster as primary heat sources. To this end, the heat pipe 7, which has a copper cladding, is guided through a wall of the respective LED lamp 3 and arranged in such a way as to make thermal contact with, or close to the base on the LED cluster. On the other hand, the heat pipe 7 is guided through a housing opening 8 to a heat transfer interface 9, attached to the housing 2 on the outside, in the form of a metal body that seals the opening 8. On the side opposite the heat pipe 7, that is to say outside the housing 2, a thermal convection heat sink 10 with cooling ribs is flanged on at the heat transfer interface 9 via a heat-conducting adhesive paste. The cooling element is thus constructed here in two pieces from the heat transfer interface 9 and the thermal convection heat sink 10. A bipartite design has the advantage of a high design flexibility, since in the event of a change in the housing shape in the region of the opening 8 only the heat transfer interface 9 need be refashioned, and, conversely, different heat sinks can be attached to a standard interface.

During operation of the LEDs, their heat is firstly conducted to the heat transfer interface 9 via the heat pipe 7 serving as heat bridge. Subsequently, the heat is transferred over a large area from the heat transfer interface 9 onto the thermal convection heat sink 10, which lies on the outside and dissipates it to the environment by thermal convection.

The heat pipe 7 is movably designed for the purpose of adjusting the lamps 3. Movability along the x-axis is achieved here by virtue of the fact that the straight sections 7a departing from the LED lamps 3 respectively have two heat pipe segments or sections that are plugged into one another in such a way as to make thermal contact and can be displaced relative to one another along the x-direction, for example 3 to 5 cm. The heat pipe 7 can then also be regarded as consisting of two pieces plugged into one another.

In the exemplary embodiment shown, the headlight housing 2 is compatible with a xenon headlight housing to the effect that the opening 8 for fastening the heat transfer interface 9 corresponds to the opening for fastening an electronic ballast, EVG, for a xenon headlight. In other words, the opening for the heat transfer interface 9 is substantially the same shape as the opening, provided for an EVG, of a xenon headlight. Consequently, no or only very little adaptation need to be carried out in the event of a switch from a xenon lamp to an LED lamp 3. Ideally, the headlight housing 2 corresponds substantially to a headlight housing for a xenon headlight, at least in its outer contour and its interfaces.

FIG. 2 shows a further embodiment of an LED headlight 11 in the case of which, by contrast to the embodiment according to FIG. 1, the heat pipe 12 is now connected to a respective heat transfer interface 9 at two different points. Heat dissipation is amplified thereby.

FIG. 3 shows yet a further embodiment of an LED headlight 14 in which the heat pipe 15 is stretched directly from heat source (LEDs or LED base of the respective LED lamp 3) to heat source. Furthermore, here the heat sink 16 is of unipartite design and fastened on the housing 17 in a fashion covering the opening 8. The heat sink 16 is equipped as a casting with cooling ribs on its top side, and has an underside that is configured for fastening on the housing 17 and has a peripheral border fitting into the opening 8, and a seal that can be mounted on the housing 17 (not illustrated).

FIG. 4 shows yet a further embodiment of an LED headlight 18 in the case of which each LED lamp 3 or the heat source(s) thereof are connected (directly or indirectly) via a dedicated heat pipe 19, 20, 21 to a respectively assigned heat sink 22, 23 and 24 in such a way as to make thermal contact.

Alternatively, the heat pipes 19, 20, 21 can be assigned a common heat sink covering the openings 8.

Of course, the present invention is not limited to the exemplary embodiments shown.

Thus, the cooling element can additionally have a blower or can be designed as a thermosyphon instead of as a thermal convection heat sink. Again, instead of using a heat pipe it is possible to use a fluid cooling system or a fluid cooling circuit with at least one flexible fluid line, specifically with or without a pump for circulating the fluid, or else a flexible heat-conducting element made from an effectively conducting material (thermal conductivity λ preferably ≧15 W/(m·K), specifically ≧200 W/(m·K)), for example a flexible copper or aluminum mesh. Thermally conductive plastics are also conceivable as heat transfer interfaces and/or for use in heat sinks. In general, it is possible in addition or as an alternative to use other passive or active cooling systems, for example with the use of one or more blowers. Combinations of various cooling elements can also be used.

At its end facing the housing, the heat pipe can be provided in planar fashion with a coupling piece that widens toward the housing, in order to improve heat transfer to the housing.

For the purpose of mobility in a number of directions, it is possible, for example, for heat pipe parts that can be displaced in relation to one another but are in thermal contact (for example plugged into one another) to be curved. More than one displacement site can be present. Apart from being plugged into one another, it is possible, for example, for two heat pipe parts arranged in a laterally offset fashion to be in thermal contact via their sides and to be displaceable along their common longitudinal axis, for example by means of a sliding bearing arranged between them.

Furthermore, the heat transfer interface need not cover an opening, but can, for example, be attached to the housing completely outside, for example by means of spacers. The heat pipe can then, for example, be guided through the housing through a narrow duct and then be guided further to the cooling element outside the housing. A unipartite design of the cooling element is particularly to be recommended in this case.

The LED headlight need not only be equipped with LED lamps, but can, for example, have only at least one LED lamp. Other lamps can then have different light sources, for example an incandescent lamp (LED hybrid headlight), and need not be equipped with a heat-conducting element.

Furthermore, the LED lamps can connected in series or parallel, or be connected independently.

Again, the LED headlight is not limited to use in motor vehicles, but can, for example, also be used for other vehicles such as ships, aircraft etc, or for general lighting purposes such as, for example, for lighting buildings, for cranes etc.

### LIST OF REFERENCE NUMERALS

1 Headlight
2 Headlight housing
3 Light emitting diode
4 Front side
5 Electrical interface
6 Cable
7 Heat pipe
8 Housing opening
9 Heat transfer interface
10 Heat sink
11 Headlight
12 Heat pipe
13 Housing
14 Headlight
15 Heat pipe
16 Heat sink
17 Housing
18 Headlight
19 Heat pipe
20 Heat pipe
21 Heat pipe
22 Cooling element
23 Cooling element
24 Cooling element

1. An LED headlight, comprising:
at least one heat-conducting element that extends from at least one heat source located in a headlight housing to at least one cooling element in such a way as to make thermal contact, the cooling element being fastened at least partially outside on the headlight housing, and the heat-conducting element being adjustable.

2. The LED headlight as claimed in claim 1, wherein the heat-conducting element comprises at least one heat pipe.

3. The LED headlight as claimed in claim 1,
wherein the heat-conducting element has at least two heat pipe parts that are in thermal contact with one another and are arranged displaceably in relation to one another.

4. The LED headlight as claimed in claim 2, wherein the heat-conducting element comprises a cooling circuit with at least one fluid line that is filled with a coolant.

5. The LED headlight as claimed in claim 4, further comprising:
a pump for circulating the coolant.

6. The LED headlight as claimed in claim 1,
wherein the cooling element has a heat-conducting heat transfer interface that is set up for fastening to a heat sink arranged outside the headlight housing.

7. The LED headlight as claimed in claim 1
wherein the cooling element has a thermal convection heat sink.

8. The LED headlight as claimed in claim 1,
wherein the cooling element has a blower.

9. The LED headlight as claimed in claim 1,
wherein the cooling element has a thermosyphon.

10. The LED headlight as claimed in claim 1,
wherein the heat-conducting element is guided through an opening in the headlight housing.

11. The LED headlight as claimed in claim 10, wherein the cooling element covers the opening on the outside.

12. The LED headlight as claimed in claim 1,
wherein the headlight housing is compatible with a xenon headlight housing, and the cooling element instead of an electronic ballast for a xenon headlight is fastened on the headlight housing.

13. The LED headlight as claimed in claim 1,
wherein the LED headlight comprises an LED vehicle headlight.

14. The LED headlight as claimed in claim 3,
wherein the heat-conducting element has at least two heat pipe parts that are plugged into one another.

15. The LED headlight as claimed in claim 3,
wherein the heat-conducting element has at least two heat pipe parts arranged in a fashion laterally offset from one another.

16. The LED headlight as claimed in claim 1,
wherein the heat-conducting element is designed in a fashion widened toward the housing.

17. The LED headlight as claimed in claim 1,
wherein the heat-conducting element is of flexible design.
